(19) United States
(12) Patent Application Publication
(10) Pub. No.: US 2025/0385502 A1
(43) Pub. Date: Dec. 18, 2025

(54) MOLDED CABLE SEAL GLAND

(71) Applicant: Bentek Corporation, San Jose, CA (US)

(72) Inventor: Robert Joseph Hannum, Mountain View, CA (US)

(21) Appl. No.: 18/742,795

(22) Filed: Jun. 13, 2024

(51) Int. Cl. H02G 15/013; H02G 3/06

(52) U.S. Cl. CPC H02G 15/013; H02G 3/0641

(57) ABSTRACT

In one or more embodiments, system and method for providing molded seal glands for cables are disclosed. In an embodiment, the system for providing molded seal gland for cables includes at least one cable and a seal gland for the cables where the seal gland is molded to at least one cable forming an assembly that is ready for installation in a panel or an enclosure. In an embodiment, the method for providing molded seal gland for cables includes molding the seal gland for the cable to at least one cable forming an assembly such that they are ready for installation in a panel or an enclosure.

### FIELD OF THE INVENTION

The embodiments described herein relate generally to cable seal glands and more particularly to cable seal glands for cables going through an enclosure.

### SUMMARY

In one or more embodiments, system and method for providing a molded seal gland for a cable are disclosed.

In one or more embodiments, the system for providing a molded seal gland for cable includes at least one cable and a seal gland for at least one cable where the seal gland is molded to the cable forming an assembly that is ready for installation in a panel or an enclosure.

In one or more embodiments, the method for providing molded seal gland for a cable includes molding the seal gland for cable to at least one cable forming an assembly that is ready for installation in a panel or an enclosure.

In one or more embodiments, the seal gland includes a cable gland and a seal, and wherein the gland and the seal are provided with a sealing mechanism for a tight assembly with the enclosure.

In one or more embodiments, the sealing mechanism for a tight assembly with the enclosure includes a snapping mechanism.

In one or more embodiments, the sealing mechanism for a tight assembly with the enclosure includes a pinning mechanism.

In one or more embodiments, the seal gland is made of a material that is same as that of the cable.

In one or more embodiments, the seal gland is made of a material that is compatible with that of the cable.

In one or more embodiments, each cable includes one or more cables or wires within itself.

### BRIEF DESCRIPTION OF THE DRAWINGS

FIG. 1 illustrates an example method for providing a molded seal gland for a cable according to one or more embodiments described herein.

FIGS. 2A and 2B illustrate an example system including a molded seal gland for a cable according to one or more embodiments described herein.

FIGS. 3A and 3B illustrate example systems including a molded seal gland for a cable illustrating a snapping mechanism and a pinning mechanism respectively according to one or more embodiments described herein.

FIGS. 4A through 4E illustrate an example snapping mechanism during installation of a system including a molded seal gland for a cable according to one or more embodiments described herein.

FIGS. 5A through 5B illustrate an example pinning mechanism during installation of a system including a molded seal gland for a cable according to one or more embodiments described herein.

### DETAILED DESCRIPTION

The embodiments described herein relate generally to cable seals and more particularly to cable seals for cables going through an enclosure.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Various methods are used to have cables seal when going into an enclosure of some sort. The following embodiments described herein are unique and improved methods/devices that provide cable seals for cables going through an enclosure.

In one or more embodiments, system and method for providing a molded seal gland for a cable are disclosed.

In one or more embodiments, the system for providing a molded seal gland for a cable includes at least one cable and a seal gland for at least one cable where the seal gland is molded to the cable forming an assembly that is ready for installation in a panel or an enclosure.

In one or more embodiments, the method for providing molded seal gland for a cable includes molding the seal gland for a cable to at least one cable or wire forming an assembly that is ready for installation in a panel or an enclosure.

In one or more embodiments, the seal gland includes a cable gland and a seal, and wherein the gland and the seal are provided with a sealing mechanism for a tight assembly with the enclosure.

In one or more embodiments, the sealing mechanism for a tight assembly with the enclosure includes a snapping mechanism.

In one or more embodiments, the sealing mechanism for a tight assembly with the enclosure includes a pinning mechanism.

In one or more embodiments described above, the seal gland is made of a material that is same as that of the cable.

In one or more embodiments described above, the seal gland is made of a material that is compatible with that of the cable.

In one or more embodiments described above, at least one cable may include one or more cables or wires within itself.

The purpose of this device/system and method is to make a quick and easy seal when the cables are inserted into an enclosure or a panel of some sort. A person skilled in the art may readily understand that this device/method could be utilized in a multitude of indoor and/or outdoor power cabling configurations and is within the spirit and scope of the present invention described herein.

The device/system according to one or more embodiments described herein includes at least one cable or wire and a seal gland for cables where the seal gland for cables is molded to at least one cable or wire to form an assembly, referred to herein as a molded seal gland for cables, that is ready for installation in a panel or an enclosure.

The device/system according to one or more embodiments described herein is easier to install in the panel and/or enclosure, cheaper to make, and provides better functionality and tighter sealing with the enclosure that is longer lasting, easier to maintain and easier to replace. The tight sealing or assembly referred to herein may be an Underwriters Laboratories (UL) rated, watertight seal.

Traditionally different seal/gland sizes for different wires and cables are used that are separate and the cables have to be manually inserted through them. It not only requires manual labor, but also results in shorter life span of such seals due to the variation of the materials between the glands and the cable. Due to the variation of the materials between the glands and the cable, there is never a perfect long-lasting seal and may require extra efforts of first installing the gland then installing the cable/wire.

The method and system described herein provides at least one cable or wire and a seal gland for cables where the seal gland for cables is molded to at least one cable or wire to form an assembly that is ready for installation in a panel or an enclosure. Since it provides the seal gland that is molded to at least one cable or wire as an assembly, referred to herein as a molded seal gland for cables, it is easier to install with a smaller number of steps and may last longer because of compatibility between the cable and the gland material.

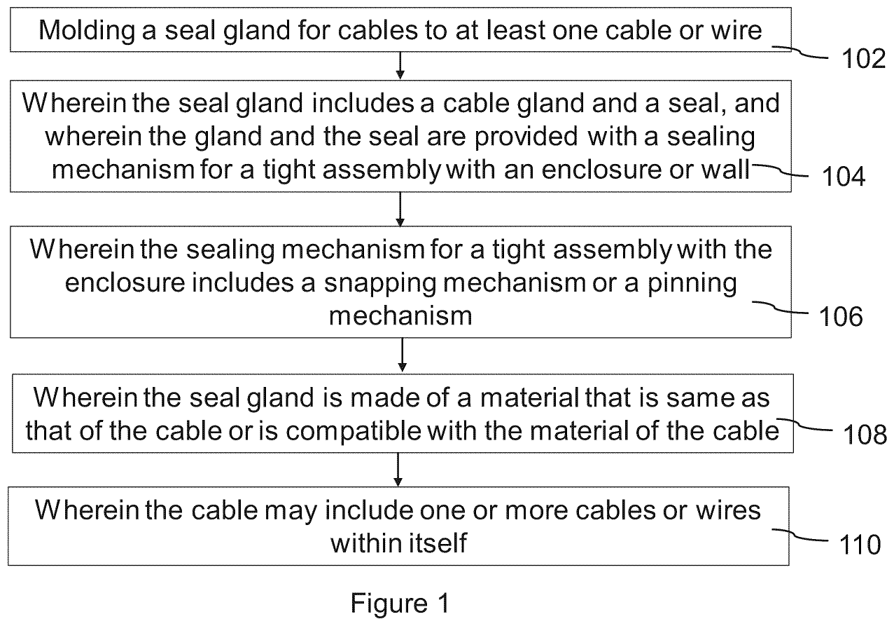

FIG. 1 illustrates an example method for providing a molded seal gland for a cable according to one or more embodiments described herein. In one or more embodiments, the method for providing a molded seal gland for a cable includes molding the seal gland for cables to at least one cable or wire such that it is ready for installation as an assembly in a panel or an enclosure via step 102.

In one or more embodiments, the seal gland includes a cable gland and a seal, and wherein the gland and the seal are provided with a sealing mechanism for a tight assembly with the enclosure via step 104.

In one or more embodiments, the sealing mechanism for a tight assembly with the enclosure a snapping mechanism or a pinning mechanism via step 106.

The seal gland may be made of a material that is same as that of at least one cable, step 108.

The seal gland may be made of a material that is compatible with that of at least one cable, step 108.

In one or more embodiments described above, at least one cable may include one or more cables or wires within itself, step 110.

The purpose of this method is to make a quick and easy seal when the cables are inserted into an enclosure or a panel of some sort. A person skilled in the art may readily understand that this device/method could be utilized in a multitude of indoor and/or outdoor power cabling configurations and is within the spirit and scope of the present invention described herein.

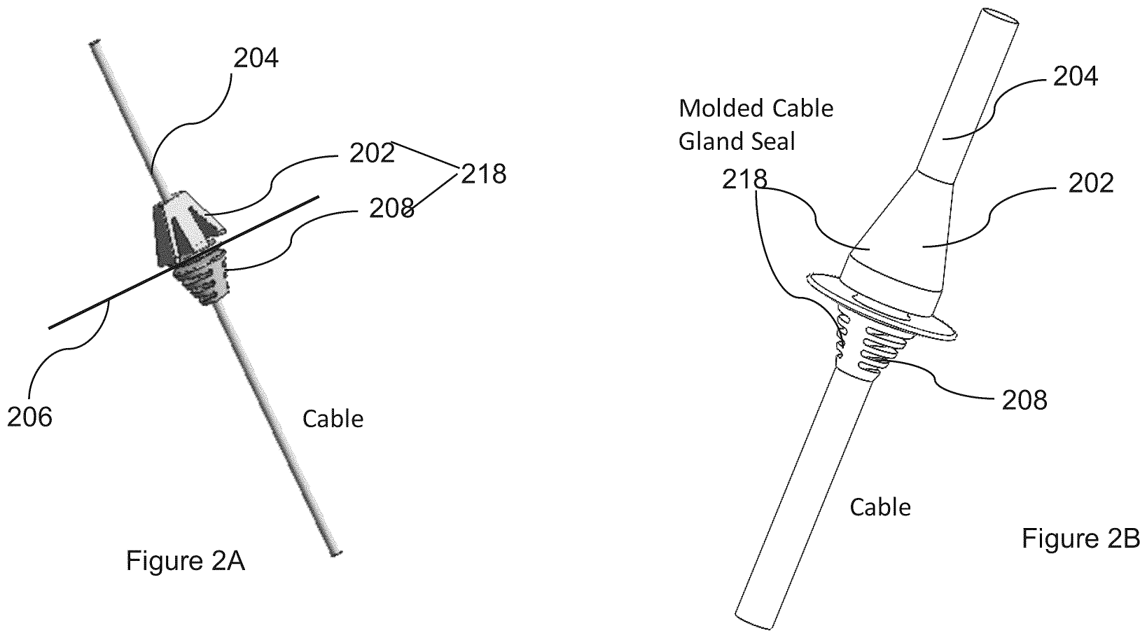

FIGS. 2A and 2B illustrate an example system including a molded seal gland for at least one cable according to one or more embodiments described herein. In one or more embodiments, the system for providing molded seal gland for cables includes a cable 204, and a gland for cables 202 and a seal 208 forming a seal gland 218, where the seal gland 218 is molded to at least one cable or wire 204 that is ready for installation in a wall of a panel or an enclosure 206.

The seal gland 218 includes a cable gland 202 and a seal 208, and wherein the gland 202 and the seal 208 are provided with a sealing mechanism for a tight assembly with the enclosure 206.

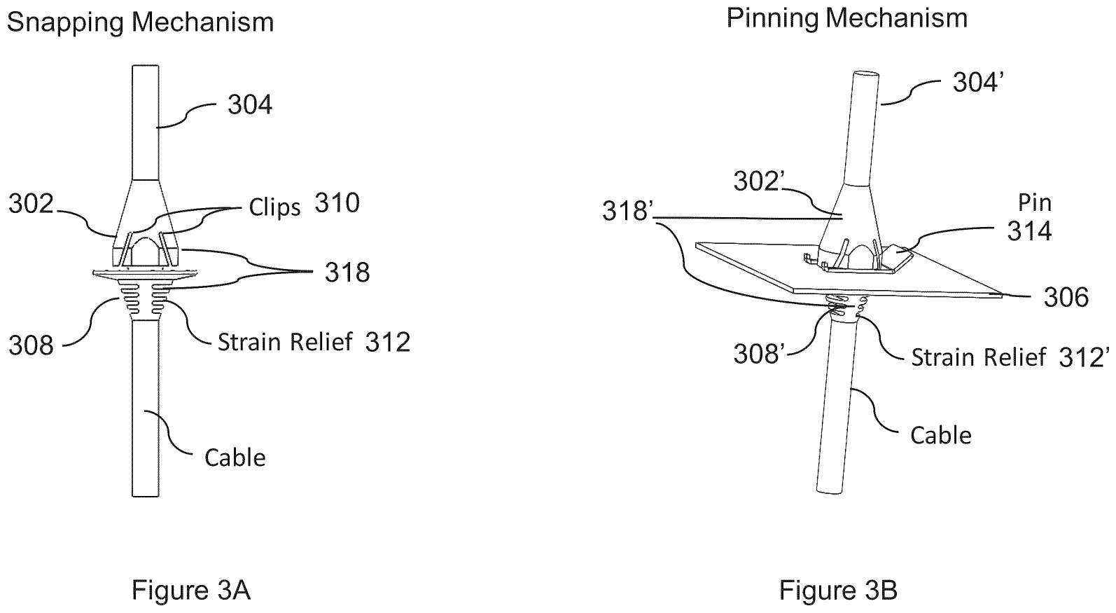

The gland 202 and the seal 208 assembly referred to herein as molded cable gland seal 218, may be provided with a snapping mechanism or a pinning mechanism as illustrated in FIGS. 3A and 3B respectively so that they can be snapped or pinned for a tight assembly with the enclosure, such as but not limited to a watertight seal.

In one or more embodiments, the seal gland 218 is made of a material that is same as that of the cable 204.

In one or more embodiments, the seal gland 218 is made of a material that is compatible with that of the cable 204.

In one or more embodiments described above, the cable 204 may include one or more cables or wires within itself.

As illustrated in FIGS. 3A and 3B, the gland and seal may be provided with a snapping mechanism as illustrated in FIG. 3A or a pinning mechanism as illustrated in FIG. 3B so that they can be snapped or pinned for a tight assembly.

As Illustrated in FIGS. 3A and 3B, in one or more embodiments, the system for providing molded seal gland for cables includes at least one cable 304 and 304′ respectively, and a seal gland for cables 318 including 302 and 308 respectively, where the seal gland 302, 302′ and 308, 308′ is molded to at least one cable or wire 304 and 304′ respectively that is ready for installation as an assembly in a panel or an enclosure 306 as molded cable gland seal assembly 318 and 318′ respectively.

As illustrated in FIG. 3A, clips 310 are provided for snapping mechanism for a tight assembly with the enclosure.

As illustrated in FIG. 3B, pin 314 is provided for pinning mechanism for a tight assembly with the enclosure.

As illustrated in FIGS. 3A and 3B, a strain relief mechanism 312 may be provided to reduce the strain on the gland-seal apparatus when snapped or pinned in place.

In one or more embodiments, the seal gland, for example, 318, 318′, is made of a material that is same as that of at least one cable, for example, 304, 304′ respectively.

In one or more embodiments, the seal gland, for example, 318, 318′, is made of a material that is compatible with that of at least one cable, for example, 304, 304′ respectively.

In one or more embodiments described above, at least one cable, for example, 304, 304′, may include one or more cables or wires within itself.

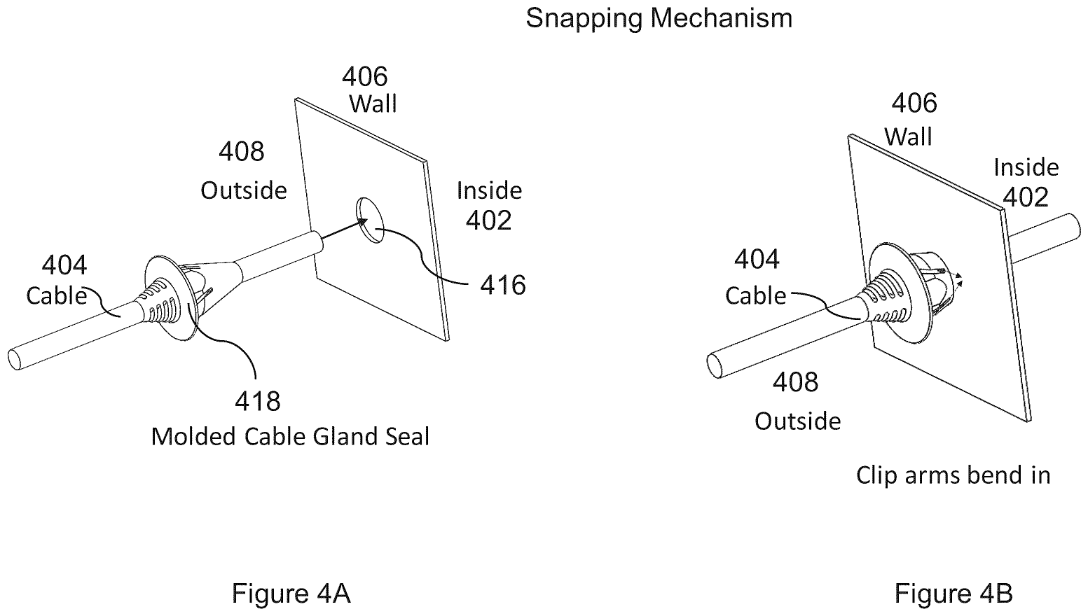

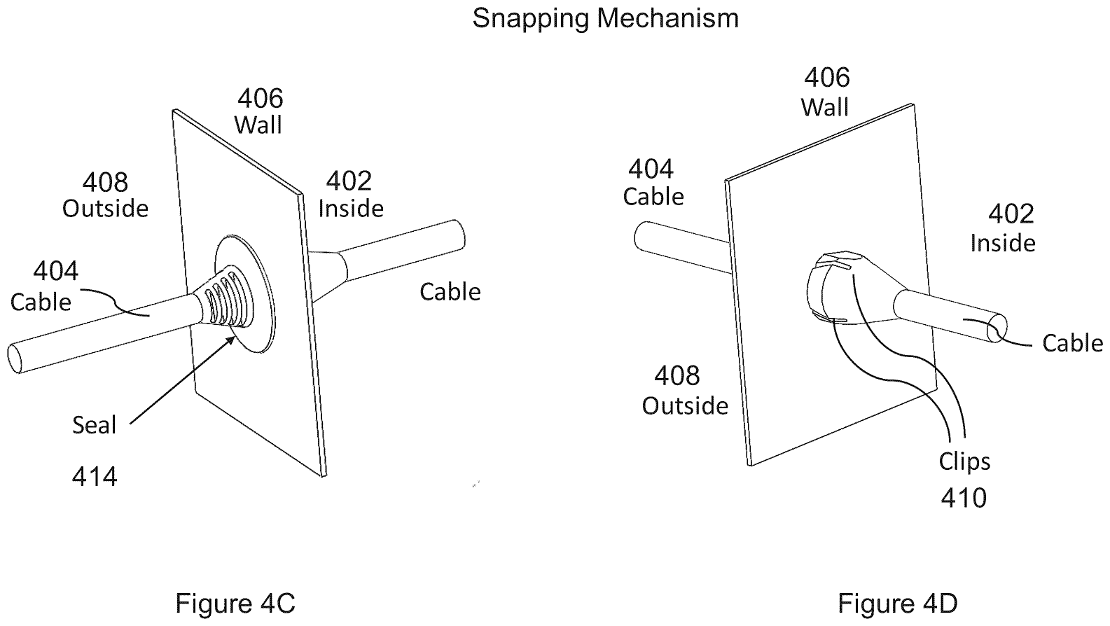

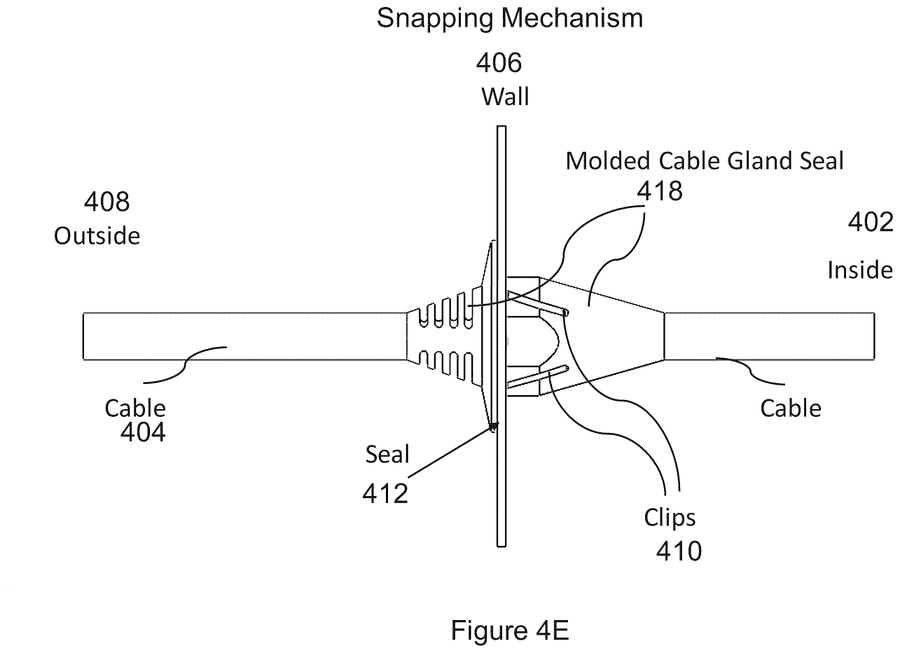

FIGS. 4A through 4E illustrate an example snapping mechanism during installation of a system including a molded seal gland for a cable according to one or more embodiments described herein. For example, FIGS. 4A and 4B illustrate the insertion of the molded cable gland seal 404 apparatus with clips 410 provided for a snapping mechanism that bend inwards during insertion through an opening 416 of the enclosure or wall 406. FIGS. 4C, 4D and 4E illustrate a seal 414 formed at the opening 416 after the insertion of the molded cable gland seal apparatus 418 with clips 410 provided for a snapping mechanism through the opening 416. FIGS. 4D and 4E illustrate the clips 410 provided for a snapping mechanism revert to their position before insertion once the insertion through the opening 416 is complete and a tight seal is formed.

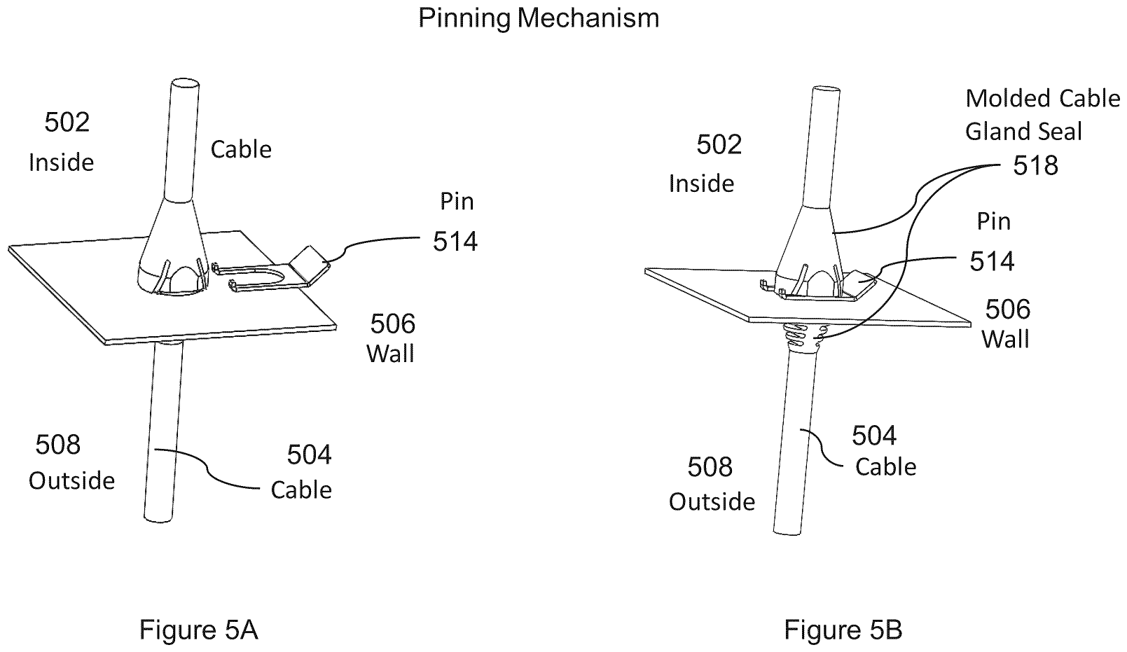

FIGS. 5A through 5B illustrate an example pinning mechanism during installation of a system including a molded cable seal gland 518 for a cable 504 according to one or more embodiments described herein. For example, FIGS. 5A and 5B illustrate the insertion of the molded cable gland seal apparatus 518 with a pin 514 provided for a pining mechanism through an opening of the enclosure or wall 506. FIG. 5B illustrates a seal formed at the opening after the insertion of the molded cable gland seal apparatus 518 with a pin 514 provided for a pining mechanism through an opening of the enclosure or wall 506.

Although the working of snapping mechanism is illustrated in detail here, other mechanisms such as pinning mechanism and any other mechanisms capable of providing a tight seal and/or a water-tight seal can be used to achieve a seal using a cable gland-seal apparatus can also be used and are within the spirit and scope of this invention.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

As used herein the terms product, device, appliance, etc. are intended to be inclusive, interchangeable, and/or synonymous with one another and other similar equipment for purposes of the present invention though one will recognize that functionally each may have unique characteristics, functions and/or operations which may be specific to its individual capabilities.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

1. A cable assembly comprising:
at least one cable having insulation; and
a seal gland molded to the at least one cable at a location along a length of the cable, the seal gland forming an integrated assembly that is ready for installation in a panel or an enclosure, the at least one cable having insulation extending on either side of the integrated assembly.

2. The cable assembly of claim 1, wherein the seal gland comprises a cable gland and a seal, and wherein the gland and the seal are provided with a sealing mechanism configured to provide a tight assembly with the enclosure.

3. The cable assembly of claim 2, wherein the sealing mechanism for a tight assembly with the enclosure comprises a snapping mechanism.

4. The cable assembly of claim 2, wherein the sealing mechanism for a tight assembly with the enclosure comprises a pinning mechanism.

5. The cable assembly of claim 1, wherein the seal gland is made of a material that is same as that of the at least one cable.

6. The cable assembly of claim 1, wherein the seal gland is made of a material that is compatible with that of the at least one cable.

7. The cable assembly of claim 2, wherein the tight assembly comprises a water-tight seal.

8. A method for providing a cable assembly comprising:
providing at least one cable having insulation; and
molding a seal gland to the at least one cable at a location along a length of the at least one cable to form an integrated assembly that is ready for installation in a panel or an enclosure, the at least one cable having insulation extending on either side of the integrated assembly.

9. The method of claim 8, wherein the seal gland comprises a cable gland and a seal; and wherein the gland and the seal are provided with a sealing mechanism for a tight assembly with the enclosure.

10. The method of claim 9, wherein the sealing mechanism for a tight assembly with the enclosure comprises a snapping mechanism.

11. The method of claim 9, wherein the sealing mechanism for a tight assembly with the enclosure a pinning mechanism.

12. The method of claim 8, wherein the seal gland is made of a material that is same as that of the at least one cable.

13. The method of claim 8, wherein the seal gland is made of a material that is compatible with that of the at least one cable.

14. The method of claim 9, wherein the tight assembly comprises a water-tight seal.

15. The cable assembly of claim 1, further comprising a strain relief mechanism integrally formed with the seal gland.

16. The method of claim 8, wherein molding the seal gland further comprises molding a strain relief mechanism to form the integrated assembly.
